(19) United States
(12) Patent Application Publication
(10) Pub. No.: US 2020/0311283 A1
(43) Pub. Date: Oct. 1, 2020

(54) A METHOD OF GENERATING INVARIANTS FOR DISTRIBUTED ATTACK DETECTION, AND APPARATUS THEREOF

(71) Applicant: Singapore University of Technology and Design, Singapore (SG)

(72) Inventors: Muhammad Azmi UMER, Karachi (PK); Aditya MATHUR, Singapore (SG); Khurum Nazir JUNEJO, Karachi (PK); Sridhar ADEPU, Singapore (SG)

(21) Appl. No.: 16/754,732

(22) PCT Filed: Oct. 23, 2018
(86) PCT No.: PCT/SG2018/050522

§ 371 Date: Apr. 8, 2020

(30) Foreign Application Priority Data
Oct. 24, 2017 (PK) 548/2017

(51) Int. Cl. G06F 21/57; G05B 19/045; G05B 19/042; G06F 21/55

(52) U.S. Cl. CPC G06F 21/577; G06F 21/554; G05B 19/0428; G05B 19/045

(57) ABSTRACT

A method 300 of generating invariants for distributed attack detection on a cyber-physical system 100 having a number of system components is provided. In a described embodiment, the method 300 includes deriving design invariants at 310 based on system design of the cyber physical system 100 including physical specifications of the system components, obtaining operational data of the cyber physical system at 320 including operational attributes of the system components, generating operational invariants from the obtained operational data at 330, and correlating the operational variants with the design invariants at 340 to generate an integrated set of invariants for detecting distributed cyber attacks of the cyber physical system 100.

### FIELD AND BACKGROUND

The present disclosure relates to a method of generating invariants for detecting cyber-attacks, and more particularly but not exclusively, to a method of generating invariants for detecting distributed cyber-attacks on a cyber-physical system having a number of system components, and also to an apparatus thereof.

Cyber-physical systems integrate physical processes with computation and networking capabilities allowing monitoring and control of process components using embedded computers and networking systems. Such cyber-physical systems are vulnerable to both physical and cyber attacks. While employing physical security to guard a walled facility may be necessary to prevent physical attacks, it is not sufficient to prevent or detect cyber attacks. When the cyber-physical system is deployed in a critical infrastructure such as a water treatment plant or power generation facility, it becomes even more critical to prevent successful attacks on these systems. There has been continued increase in the number of security related incidents on such infrastructures. For example, a report indicated 25 incidents on water systems out of a total of 295 reported incidents in one year. Of these incidents, 22 of the attacks had reached “Level 6-Critical Systems”. Given the dependence on water, power, and other critical infrastructure, it is important that such infrastructure be secured against both external and internal malicious actors.

A proposed method for detecting cyber-physical attacks on critical infrastructure included theoretical and simulation studies on distributed attack detection in power grids, water treatment plants, and automotive systems. The method used state-based invariants to identify deviation of the plant process from its normal behaviour, also termed as process anomaly. A design-centric (DeC) approach was proposed to derive such invariants. The invariants were derived directly from plant design such as a Process and Instrumentation Diagram (P&ID) for water treatment or a Line Diagram for power generation systems. The proposed method produced invariants that were coded and installed inside controllers or placed on the plant communications network to serve as process monitors. An alert was generated when any one invariant has been violated, i.e. evaluated to false. However, the alert was indicative of process anomaly that could have been due to a fault in one or more components of the plant or a cyber attack.

Invariant generation and analysis using machine learning techniques have also been attempted. However, the techniques that are known have not been able to detect distributed attacks to a satisfactory degree of accuracy to ensure critical infrastructures are secured against both external and internal malicious actors.

Therefore, it is desirable to provide a method of generating invariants for distributed attack detection which addresses at least one of the drawbacks of the prior art and/or to provide the public with a useful choice.

### SUMMARY

Various aspects of the present disclosure will now be described in order to provide a general overview of the present disclosure. The following summary, by no means, delineate the scope of the invention.

According to a first aspect, there is provided a method of generating invariants for distributed attack detection on a cyber physical system having a number of system components. The method includes (i) deriving design invariants based on system design of the cyber physical system including physical specifications of the system components, (ii) obtaining operational data of the cyber physical system including operational attributes of the system components, (iii) generating operational invariants from the obtained operational data, and (iv) correlating the operational invariants with the design invariants to generate an integrated set of invariants for detecting distributed cyber attacks of the cyber physical system.

Advantageously, by integrating design invariants with operational invariants, the integrated set improves the accuracy of distributed attack detection and reduces false alarms.

The operational invariants may be validated operational invariants.

Producing the validated operational invariants may include validating the operational invariants against the system design of the cyber physical system.

Obtaining the operational data may include collecting network packets, decoding the network packets for state information of sensors to derive the operational attributes of the system components, and producing an invariant dataset for generating the operational invariants.

The method may further include reducing the invariant dataset to produce a reduced invariant dataset for generating the operational invariants.

Producing the reduced invariant dataset may include processing the operational attributes of the system components to produce discrete valued attributes.

The operational attributes may be real valued attributes, and producing discrete valued attributes may include discretizing the real valued attributes to binary valued attributes.

The method may further include monitoring the sensors corresponding to the system components of the discrete valued attributes for changes in the discrete values over a specific period of time.

The method may further include selecting operational attributes which exhibit change in the discrete values as part of the reduced invariant dataset for generating the operational invariants.

The method may further include forming one or more of the discrete valued attributes into itemsets, and selecting the itemsets that satisfy a preselected minimum support level as part of the reduced invariant dataset.

The method may further include generating association rules that satisfy a preselected minimum confidence level from the itemsets. The operational invariants may be the association rules for defining a relationship between the operational attributes of each system component.

Correlating the operational invariants with the design invariants may include comparing the operational invariants to the design invariants, and removing highly correlated attributes to form the integrated set of invariants.

The method may further include coding the integrated set of invariants as respective computer codes, and programming controllers with the respective computer codes for monitoring process anomalies in the cyber physical system.

The cyber physical system may be a water treatment or power generation plant.

According to a second aspect, there is provided an apparatus for generating invariants to detect distributed attacks on a cyber physical system having a number of system components. The apparatus includes a first invariant generator configured to derive design invariants based on system design of the cyber physical system including physical specifications of the system components, a data collector configured to obtain operational data of the cyber physical system including operational attributes of the system components, a second invariant generator configured to generate operational invariants from the obtained operational data, and a processor configured to correlate the operational invariants with the design invariants to generate an integrated set of invariants for detecting distributed cyber attacks on the cyber physical system.

The operational invariants may be validated operational invariants.

The apparatus may further include a rule validation processor configured to validate the operational invariants against the system design of the cyber physical system to produce the validated operational invariants.

### BRIEF DESCRIPTION OF DRAWINGS

Exemplary embodiments will now be described with reference to the accompanying drawings, in which:

FIG. 1 is a pictorial representation of a communications network implemented in a water treatment plant;

FIG. 2 is a schematic representation of a physical layer of the water treatment plant of FIG. 1;

FIG. 3 is a flow diagram showing an exemplary method of generating an integrated set of invariants for detecting a distributed attack on the water treatment plant of FIG. 1;

FIG. 4 a schematic diagram of a water tank being used in the physical layer shown in FIG. 2;

FIG. 5 is a flow chart for an apparatus which implements the method described in FIG. 6.

FIG. 6 is a flow diagram showing an exemplary method 600 which implements the method described in FIG. 3 on the apparatus described in FIG. 5.

### DETAILED DESCRIPTION

One or more embodiments of the present disclosure will now be described with reference to the figures. It should be noted that the use of the term “an embodiment” in various parts of the specification does not necessarily refer to the same embodiment. Features described in one embodiment may not be present in other embodiments, nor should they be understood as being precluded from other embodiments merely by the absence of the features from those embodiments. Further, various features described may be present in some embodiments and not in others.

Additionally, figures have been provided to aid in the description of the preferred embodiments. The figures and the following description should not take away from the generality of the preceding summary. The following description contains specific examples for illustrative purposes. The person skilled in the art would appreciate that variations and alterations to the specific examples are possible and within the scope of the present disclosure. For illustrative purposes, specific embodiments are described with respect to a Secure Water Treatment Plant (SWaT) which utilizes a cyber physical system. However, it should be understood that the embodiments are equally applicable to other infrastructures e.g. a power generation plant, that employ cyber physical systems.

### SWaT: A Water Treatment Plant

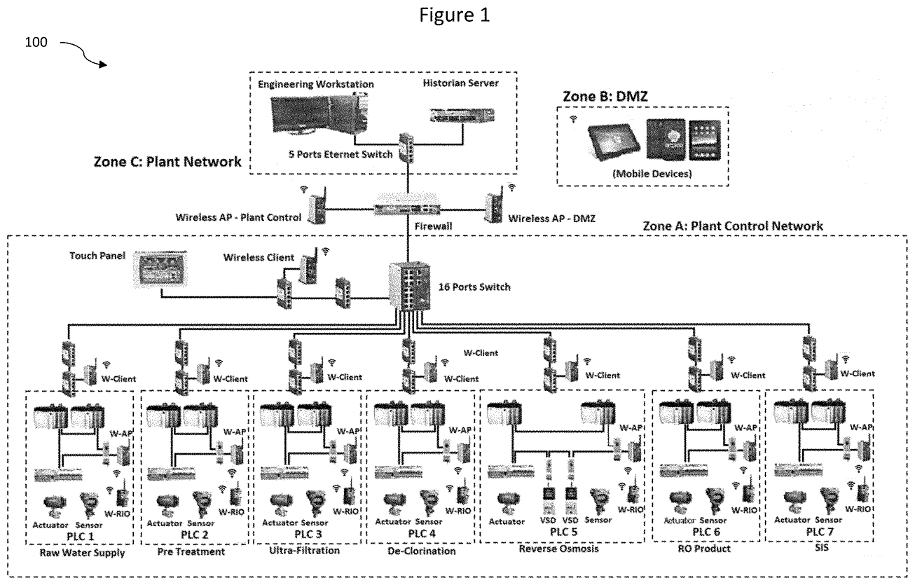

FIG. 1 illustrates the SWaT 100 having a multi-layer network divided into Zone A (Plant Control Network), Zone B (demilitarized zone—DMZ), and Zone C (Plant Network). Zone B may not be implemented in some cases depending on whether a demilitarized zone is required. Additionally, PLC7 is a stand-by unit and not used in some cases.

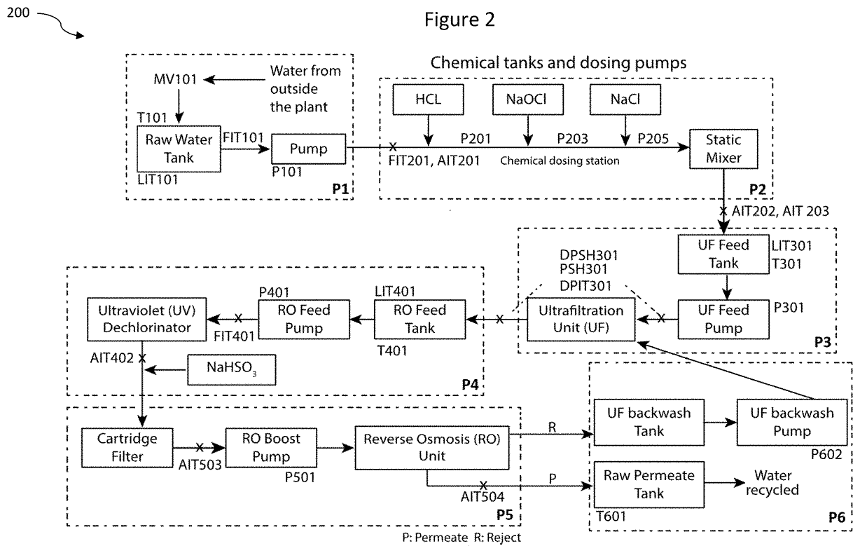

The physical layer 200 of the SWaT 100 is herein described with reference to FIG. 2. The SWaT 100 is a six-stage plant that produces five gallons/minute of treated water. The plant can operate non-stop 24/7 in fully autonomous mode. FIG. 2 illustrates the six sub-processes in the plant, one corresponding to each stage.

The following notations are used in FIG. 2 to represent the physical infrastructure used in the physical layer 200:

Programmable Logic Controller (PLC):

Px x={1, 2, 3, 4, 5, 6} for each stage of the treatment

### Sensors:

| | |
|---|---|
| LITxxx | Water level sensor |
| FITxxx | Water flow sensor |
| AITxxx | Chemical property analyzer |
| DPITxxx | Differential pressure sensor |

### Actuators:

| | |
|---|---|
| Txxx | Tank |
| Pxxx | Pump |
| MVxxx | Motorized Valve |
| PSHxxx | High pressure switch |

Referring to FIG. 2, each sub-process/stage is controlled by a PLC—P1, P2, P3, P4, P5, and P6 respectively. The state of each sub-process is measured using the sensors while the control is effected via the actuators. For example, in the first sub-process, a motorized valve MV101 controls the flow of water into a tank T101, while a water level sensor LIT101 measures the water level in the tank T101.

Sensors and actuators: The physical layer 200 of SWaT 100 contains a total of 68 sensors and actuators. It should be noted that not all of the sensors and actuators are shown in FIG. 2. Further, some actuators serve as standbys and are intended to be used only when the primary actuator fails.

Plant supervision and control: A Supervisory Control and Data Acquisition (SCADA) workstation is located in the plant control room. Data or control access to nearly all plant components is available via this workstation. A plant operator can view process state and set process parameters via the workstation. A Human Machine Interface (HMI) is also located inside the plant room and can be used to view process state and set parameters. Control code can be loaded into each PLC via the workstation. A historian is available for recording process state as well as network packet flows at preset time intervals.

Communications: With reference to FIG. 1, the multi-layer network enables communication across all components of the SWaT 100. The ring network at each stage at level 0 enables PLCs to communicate with sensors and actuators at the corresponding stage. A star network at level 1 enables communications across PLCs, SCADA, HMI and the historian. Both wired and wireless options are available at level 1 and also for communications with the sensors at level 0.

SWaT operation: Operation of the plant is initiated by an operator at the SCADA workstation and, when needed, can be controlled. State information can be viewed at the workstation or at the HMI, and is recorded in the historian. Process anomaly detectors, i.e. monitors, developed by researchers have been installed in SWaT 100. Detectors generate visual alerts and send messages to the operator. All alerts generated by the monitors, i.e. coded invariants, are recorded in the historian. SWaT 100 can be attacked by compromising its communications network at all levels as well as directly by accessing the PLCs, the SCADA workstation, and the HMI. Physical attacks are feasible in SWaT 100 through several means such as by replacing or removing sensors, disconnecting wires between sensors/actuators and the PLCs, removing power to one or more actuators.

### Invariants

While physical attacks on the physical layer 100 may be prevented through physical security, this is inadequate to prevent cyber attacks. The embodiments described herein therefore use invariants to detect and prevent cyber attacks on the multi-layer network. An invariant is a condition that holds during the operation of a physical plant when the plant is in a given state.

Let X(t) denotes a time (t) dependent n-dimensional state vector for the plant consisting of state variables that can be observed via sensors. X(t)=X_{c}(t)∪X_{d}(t), where X_{c}(t) and X_{d}(t) denote, respectively, vectors of continuous valued and discrete valued state variables. For example, the state of a motorized valve such as MV101, is discrete valued while the water level of tank T101 measured by level sensor LIT101 is continuous valued. It is taken that all state variables evolve with time and hence time is not explicated indicated, e.g., X≡X(t). Furthermore, state variable x∈X may be discrete or continuous.

Let f(X) and g(X) denote Boolean functions, and h(X_{c})∈R⁺ denote a function on a continuous state variable. The following types of invariants are presented.

x op v (1)

f(X)⇒g(X) (2)

h(x∈Xc)<ε (3)

where v∈R is a constant, ε>0 an error threshold, x∈X_{c} a continuous state variable, and op denotes a relational operator. Invariants of type (1) are simple and intended to check a state variable against its upper and lower limits. Such invariants might be redundant when checks are coded in the plant control algorithms. Invariants of type (2) are to be interpreted as “if f (X) then g(X).” Such an invariant is also referred to as an association rule in the description. Invariants of type (3) are used to compare predicted values of a continuous state variable with measured values from the corresponding sensor. The error threshold ε is determined based on the error in the measurements reported by the corresponding sensor.

Each invariant is coded in an appropriate language depending on where in the plant it is placed. In SWaT 100, invariants are coded in structured text and placed inside the PLCs to serve as process monitors. These monitors can also be placed on the communications network. It is understood that the skilled person would be aware of the best location(s) for invariants in a plant.

State variables in an operational plant are sampled at pre-specified instants by obtaining measurements from the corresponding sensors. The states of actuators are obtained by sampling sensors inbuilt into the actuators. Each invariant is evaluated soon after the data is sampled. An alert is generated when any invariant evaluates to false. In distributed attack detection, functions f(X) and g(X) may use state variables from multiple stages of the plant. Thus, state vector X can be written as [X₁, X₂, . . . , Xₙ], where Xᵢ is the state vector for stage ‘i’ of a plant, where 1≤i≤n. An invariant is considered local to stage ‘i’ if it uses state variables from only stage ‘i’ i.e. a local invariant. If an invariant uses state variables from more than one stage, then it is considered a global invariant. A distributed attack on a system may occur at one or more stages of a system. Therefore, a mix of local and global invariants are used for distributed attack detection.

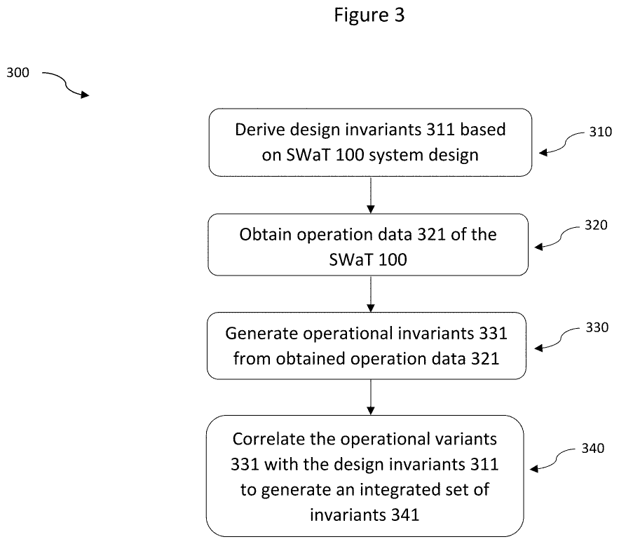

FIG. 3 is a flow diagram showing an exemplary method 300 of generating an integrated set of invariants for detecting a distributed attack on the SWaT 100.

### Deriving Design Invariants

At step 310, design invariants 311 are derived using an invariant generator. The derivation is based on the system design of the SWaT 100. System design are found in the physical specification of SWaT system components, Process and Instrumentation Diagrams (P&IDs), and State Condition Graphs (SCGs). Design invariants 311 are derived using control algorithms and the physical specification of SWaT 100. Alternatively, with a P&ID provided as input, design invariants 311 may also be generated by the invariant generator using fundamental laws of physics. Design invariants 311 may also be generated using an SCG. An SCG captures conditions needed to change the state of an actuator such as a pump or a motorized valve. These conditions lead to type (2) invariants. Type (1) invariants are derived from physical specifications of the plant components, while those of type (3) are derived from the physics of water flow.

Some examples of invariants derived from the system design of SWaT 100 are given next.

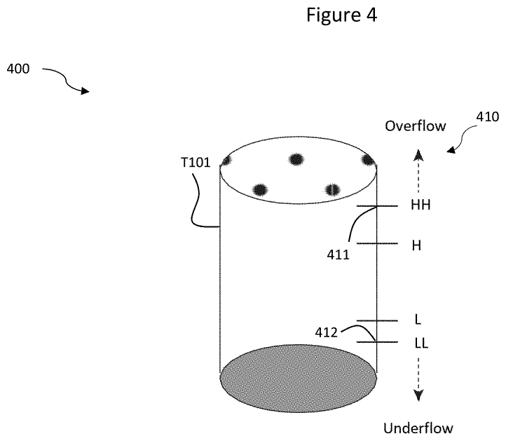

With reference FIG. 2, and tanks T101 and T301 from respective stages 1 and 3 of the SWaT 100, each tank T101 and T301 has four level markers, namely, HH (High High), H (High), L (Low), and LL (Low Low). A cross-sectional diagram 400 of tank T101 illustrating the different level markers 410 is shown in FIG. 4. These markers 410 are used by the controllers to ensure that (a) there is enough water in a tank for process continuity, and (b) there is no overflow or underflow. Note that there is adequate buffer above HH markers 411 and below LL markers 412 to ensure that stealthy attacks that are detected only when the water level reaches HH or LL, do not cause overflow or underflow. Below is a sample of invariants derived from the design corresponding to invariant types (1)-(3). Here parameter k denotes the instant when data is sampled from a sensor.

LIT101(k)<HH (4)

LIT101(k)>H⇒MV101=CLOSED (5)

LIT301(K)<L⇒P101=ON (6)

L̅I̅T̅1̅0̅1̅(k)=L̅I̅T̅1̅0̅1̅(k−1)+a(Wᵢₙ−Wₒᵤₜ) (7)

The following explains how the invariants would work to detect system anomalies. The above invariants are coded to generate alerts when they evaluate to false. For example, invariant (4) generates an alert when water level in tank T101 goes above the HH marker. Invariant (5) generates an alert if motorized valve MV101 is not CLOSED when water level in tank T101 is above the H marker. Similarly, invariant (6) generates an alert when pump P101 is OFF and the water level in tank T301 is below L. Invariant (7) is used for predicting the water level in tank T101 (L/T101) given the amount of inflow (Wᵢₙ) and outflow (Wₒᵤₜ) with a being the proportionality constant to convert flow to level in the tank. In the context of attack detection, (7) is not an invariant. Instead, it is used to create an invariant such as the following:

$$\frac{{Σ}_{i = 1}^{n} \overline{( LIT 101} ( i ) - LIT 101 ( i ) )}{n} < ∈ , \qquad ( 8 )$$

where n is the number of samples over which the average is computed and E is the error tolerance beyond which the process is considered in anomalous state. Considerations in selecting values of n and ∈ are in [2]. Table 1 lists several parameters used while coding the invariants derived.

TABLE 1
Parameters used while coding invariants.

| Sensor | Parameter | Values |
|---|---|---|
| AIT | pH | H = 7.05, L = 6.95 |
| AIT | Conductivity | H = 260, L = 250 |
| AIT | ORP | H = 480, L = 440 mV |
| FITxxx | Flow rate | H = 2.0 m L = 0.1 |
| LIT101 | Water level | HH = 1000, H = 800, |
| | | L = 500, LL = 250 |
| LIT301 | Water level | HH = 1200, H = 1000, |
| | | L = 800, LL = 250 |
| LIT401 | Water level | HH = 1200, H = 1000, |
| | | stateL = 800, LL = 250 |
| MVxxx | State transition time | 8 seconds |
| Pxxx | State transition time | 2 seconds |

Units: ORP: μS/cm; conductivity: mV; flow rate: m³/hr.

### Obtaining SWaT Dataset

At step 320, operational data 321 of SWaT 100 is obtained from publicly available datasets. Alternatively, the operational data 321 may also be collected from normal operation of SWaT i.e. “SWaT Normal Data”. For example, a data collection infrastructure can be put in place to capture and save state information generated by sensors. In SWaT 100, this data may be collected by capturing network packets, decoding the network packets for state information, and saving the state information in a historian. The operational data 321 collected will be later used to derive rules (invariants) to represent the normal behaviour/operation of SWaT 100. By doing so, the operational invariants 331 so derived are able to detect process anomalies that deviate from the normal behaviour of the SWaT 100.

To collect the normal data, SWaT 100 is started in a state in which tanks T101 and T103 are near state L, UF is active, and RO is inactive. To simulate the operation of a commercial plant, the feedback from RO tank T601 to tank T101 is disabled and all pure water generated from RO is sent to drain.

Soon after starting the data collection process, the plant moves to its full capacity of producing about 5 gallons/minute of pure water. The time-stamped dataset collected over a 7-day period consists of an Excel spreadsheet with 53 columns and 496,800 rows. Columns 1 and 53 contain, respectively, the time stamp and whether there was an attack or not. The normal data set is created without any detected attacks. The remaining columns contain the sensor data indicating the states of various plant components including tanks, valves, pumps, and meters, as well as data on chemical properties including pH, conductivity, and the Oxidation Reduction Potential (ORP).

The data collected is collated in a SWaT dataset to be used for generating operational invariants in the following step. Hence, the SWaT dataset is also termed interchangeably as an invariant dataset. For illustration, Table 2 lists some of the sample data extracted from the SWaT dataset. For example, data in the first row indicates that valve MV101 is ‘2’ or ‘OPEN’ and pump P101 is ‘2’ or CON′. The inflow and outflow rates into and from tank T101 as indicated by FIT101 and FIT102, respectively, are around 2.47 m³/hr. The nearly same inflow and outflow rates are consistent with the water level in T101 which hovers around 261 as indicated by LIT101.

TABLE 2
Sample data from SWaT dataset

| Timestamp | FIT101 | LIT101 | MV101 | P101 | FIT201 |
|---|---|---|---|---|---|
| 22/12/2015 | 2.470294 | 261.5804 | 2 | 2 | 2.471278 |
| 4:00:00 PM | | | | | |
| 22/12/2015 | 2.457163 | 261.1879 | 2 | 2 | 2.468587 |
| 4:00:01 PM | | | | | |
| 22/12/2015 | 2.439548 | 260.9131 | 2 | 2 | 2.467305 |
| 4:00:02 PM | | | | | |
| 27/12/2015 | 2.471575 | 538.8619 | 2 | 1 | 0.007432801 |
| 3:45:59 AM | | | | | |
| 27/12/2015 | 2.458764 | 539.5684 | 2 | 1 | 0.00076891 |
| 3:46:00 AM | | | | | |
| 27/12/2015 | 2.471575 | 538.8619 | 2 | 1 | 0.007432801 |
| 3:45:59 AM | | | | | |
| 28/12/2015 | 0 | 812.8069 | 1 | 1 | 0 |
| 4:30:30 AM | | | | | |
| 28/12/2015 | 0 | 812.6106 | 1 | 1 | 0 |
| 4:30:31 AM | | | | | |
| 28/12/2015 | 0 | 812.6106 | 1 | 1 | 0 |
| 4:30:32 AM | | | | | |

FIT: 0 ⇒ no flow;
MVxxx: 2 ⇒ OPEN;
1 ⇒ CLOSED;
PVxxx: 2 ⇒ ON;
1 ⇒ OFF

Deriving Operational Invariants from SWaT Dataset

At step 330, operational invariants 331 are generated from the invariant dataset i.e. operational data 321, using association rule mining. Association Rule Mining (ARM) is a rule-based machine learning method to uncover relationships between seemingly unrelated data in databases. This relationship is expressed as a rule such as LIT301(k)<L⇒P101=ON. In such rules the item to the left of is referred to as antecedent and the one to the right as the consequent. ARM is used for a variety of applications including predicting customer behaviour, product clustering, web usage mining, catalogue design, store layout, intrusion detection, and bioinformatics.

In practical applications, discovering rules, such as the one mentioned above, poses several challenges for large datasets. In particular, the number of such rules grows exponentially with respect to the total number of dimensions, also referred to as items or attributes, in the dataset. Thus, the rule generation algorithm is NP-complete. To make the problem tractable, only “interesting” rules are selected. Furthermore, other statistical techniques are applied to further reduce the number of attributes in the invariant dataset. As a result, a reduced invariant dataset is produced. This is further explained below.

### Feature Engineering and Selection

The state space of all possible rules that can be generated depends on the number of attributes and the number of unique values of each attribute in the dataset. Given a continuous valued attribute, virtually infinite rules is generated thus rendering the problem intractable. ARM therefore requires the attributes to be discrete valued whereas the SWaT dataset consists of real valued, binomial, and trinomial attributes. Therefore, it is necessary to discretize the real valued attributes to binary valued attributes to reduce the state space and consequently the set of possible rules.

In SWaT 100, sensors record the values of attributes and states of the various components. Transforming these attributes to binomial requires special care. The actuators for the most part are either in the OPEN or CLOSED state for valves and ON and OFF for pumps. However, during the transition between the two states, these attributes assume a third value, thus making them ternary valued. This transition between the two states only lasts less than 10 seconds and usually occurs after a long interval. Thus, the transition value of ternary-valued attributes was replaced by the value of the state towards which the transition was headed, i.e. to OPEN if the transition was from CLOSED to OPEN, and to CLOSED if it was from OPEN to CLOSED for a motorized valve. This change from ternary-valued attributes to binary-valued attributes further reduced the possible state space used in the ARM procedure.

To further reduce the possible set of rules, a naive feature selection may be applied. All the sensor and actuator attributes (after conversion to binary valued attributes) that did not change their values throughout the seven days of data are removed from the dataset. These included three types of attributes: all the backup actuators that remained in the OFF, or CLOSED, state during data collection because none of the active actuators failed, the actuators that were in ON, or OFF, state throughout the data collection process, and the sensor values that failed to exhibit a change in value after discretization. Consequently, none of the attributes from the processes in stages 4 and 5 qualifies for the final set of attributes, reducing the attribute set from fifty one to fifteen attributes. In this way, only dynamic attributes that gave meaningful information are selected. An exemplary list of dynamic attributes selected from the SWaT dataset is provided in Table 3.

TABLE 3
Attributes selected from ARM

| | |
|---|---|
| Attribute | Description |

Flow meters

| | |
|---|---|
| FIT101 | Measures inflow into tank T101 |
| FIT201 | Measures flow rate from stage 1 to stage 2 |
| FIT301 | Measures the flow of water in the UF stage |
| FIT601 | UF backwash flow meter |

Motorized valves

| | |
|---|---|
| MV101 | Controls water flow into tank T101 |
| MV201 | Controls flow into tank T301 |
| MV301 | Controls the UF-backwash process |
| MV302 | Controls water flow to the de-chlorination unit |
| MV303 | Controls UF backwash |
| MV304 | Controls UF backwash drain |

Pumps

| | |
|---|---|
| P101 | Pumps water from raw water tank to stage 2 |
| P203 | Dosing pump for HCl* |
| P205 | Dosing pump for NaOCl* |
| P302 | Pumps water from tanks T301 to T401 |
| P602 | Pumps water from backwash tank T602 to UF |

*HCl and NaOCl are chemicals added to water at stage 2

It is noted that highly correlated attributes may also be removed to reduce redundant attributes to further reduce the state space.

To make the problem even more tractable, only “interesting” rules are selected using statistical constraints. Rules that meet a minimum criterion of support and confidence are deemed interesting. The concept of support and confidence is explained in the following section.

### Frequent Itemset Generation

Let D denote a dataset of interest. A collection of values of one or more attributes, e.g., the pair water level and state of a motorized valve, is known as an item set. Item sets that satisfy a minimum support are referred to as frequent item sets. Support for an item set A in D is the proportion of examples (rows, or transactions) e in the dataset that contain A. Formally, support can be defined as follows.

$$\text{Support} ( A ) = \frac{\vert e ∈ D ; A ∈ e \vert}{\vert D \vert} \qquad ( 9 )$$

It should be noted that setting a high support leads to few frequent item sets and thus a conservative model, whereas a small support results in an explosion of frequent item sets which will likely include rare item sets.

### Association Rule Generation

A frequent item set can be partitioned in more than one way into antecedents and consequents to generate rules of the type X⇒Y. Only rules that satisfy a minimum confidence level defined by the user are considered as the final set of association rules. Confidence is defined as the proportion of rules that contain the antecedent which also contains the consequent; it measures how often the rule appears in the dataset when X has occurred. The confidence of a rule X⇒Y is defined as follows.

$$\text{Confidence} ( X ⇒ Y ) = \frac{\text{Support} ( X ⋃ Y )}{\text{Support} ( X )} \qquad ( 10 )$$

Thus, confidence can be interpreted as an estimate of the conditional probability Y given X for rules that also contain X. Setting a low value of confidence yields rules that may be less accurate than those generated for higher confidence. X and Y can have one, two, or more attributes depending on the size of the frequent item set.

In the present embodiments, rules are mined with 100% confidence and a minimum support of 0.77%. Furthermore, the FP-growth frequent pattern mining algorithm is used to mine the association rules. The implementation of the algorithm provided by Python Orange-Associate library is used.

Table 4 lists the exemplary invariants that are derived. Notably, the list includes a large number of global attributes as compared to local attributes. This tilt towards global attributes points to the power of distributed attack detection as global attributes are capable of detecting attacks that compromise all sensors and actuators at any one stage of SWaT 100.

TABLE 4
Sample of operational invariants 331 generated

Antecedent size = 1. Total: 28; Local: 14; Global: 14.
P602 = ON ⇒ P302 = OFF; MV101 = ON ⇒ FIT101 > H;
P101 = ON ⇒ MV201 = ON; MV303 = OFF ⇒ FIT601 < L
Antecedent size = 2. Total: 51; Local: 15; Global: 36.
MV301 = OFF, MV302 = ON ⇒ FIT301 > L
P602 = ON, MV304 = OFF ⇒ MV302 = OFF
FIT601 > L, MV304 = OFF ⇒ MV303 = ON
MV304 = ON, FIT601 < L ⇒ P602 = OFF
Antecedent size = 3. Total: 58; Local: 2; Global: 56.
P602 = ON, MV304 = OFF, FIT101 > δ ⇒ MV301 = ON
MV301 = ON, P302 = OFF, MV101 = ON ⇒ MV304 = OFF
FIT601 > stateH, MV303 = ON, FIT301 < L ⇒ MV304 = OFF
MV304 = ON, MV301 = OFF, FIT601 < L ⇒ P602 = OFF
Antecedent size = 4. Total: 51; Local: 1; Global: 50.
P602 = ON, MV304 = OFF, P302 = OFF, FIT101 > H ⇒ MV101 = ON
MV301 = ON, MV304 = OFF, P302 = OFF, FIT101 > δ MV101 = ON
FIT601 > H, MV304 = OFF, P302 = OFF, FIT101 > H ⇒ FIT301 < L
FIT301 > H, MV301 = OFF, MV303 = OFF, FIT601 < L ⇒ P602 = OFF
Antecedent size = 5. Total: 27; Local: 0; Global: 27.
P602 = ON, FIT301 < L MV304 = OFF, FIT101 > H, MV101 = ON ⇒ P302 = OFF
MV301 = ON, FIT301 < L, MV302 == OFF, MV304 = OFF, P302 = OFF ⇒ FIT101 > H
FIT601 > H, FIT301 < L, MV304 = OFF, FIT101 > H, MV101 = ON ⇒ P302 = OFF
FIT101 < L, MV101 = OFF, MV301 = OFF, MV303 = OFF, FIT601 < L P602 = OFF
Antecedent size = 6. Total: 9; Local: 0; Global: 9.
P602 = ON, MV302 == OFF, MV304 = OFF, P302 = OFF, FIT101 > H, MV101 = ON ⇒ MV301 = ON
MV301 = ON, FIT301 < δ, MV302 = OFF, MV304 = OFF, P302 = OFF, FIT101 > H ⇒ MV101 = ON
FIT601 > H, FIT301 < L MV302 = OFF, MV303 = ON, P302 = OFF, MV101 = ON ⇒ MV304 = OFF
Antecedent size =7. Total: 2; Local: 0; Global: 2.
P602 = ON, FIT301 < δ, MV301 = ON, MV302 = OFF, MV304 = OFF, P302 = OFF, FIT101 > H ⇒ MV101 = ON
FIT601 > H, FIT301 < L, MV302 = OFF, MV303 = ON, MV304 = OFF, P302 = OFF, FIT101 > H ⇒ MV101 = ON
The comma (,) in the antecedent of a rule is to be interpreted as a Boolean ‘AND’.

In general, the following two challenges have to be overcome when deriving the operational invariants 331.

Transformation of Attributes:

Some of the attributes in the dataset are real valued while usually ARM works on binomial attributes. Transforming these real valued attributes into binomial attributes is a challenging task as the absence of proper boundaries may lead to incorrect rules or rules with low accuracy. There is also a problem with the trinomial attributes that represent the motorized valve that enters the transition state. Hence, changing this transition state to either ON (OPEN), or OFF (CLOSED) state is important or else false alarms may be generated.

Very Large Set of Rules:

Association rule mining generates a large set of rules most of which have low accuracy. The number of rules could be controlled through support threshold. However, increasing the support level may cause loss of important rules that do not have enough occurrences in the dataset to meet the support threshold. On the other hand, reducing the support threshold would generate a large set of rules. Notably, there are some attributes with low items in the dataset. For example, there are 3164 items where P602=ON and the total number of items is 410400. This implies that any rule containing P602=ON could have a maximum support of 3164/410400, i.e. 0.77%. Hence, without decreasing the support up to this level, no rule including P602=ON can be generated. Consequently, a large set of rules needs to be scanned in order to get meaningful and accurate rules.

### Generating Integrated Set of Invariants

At step 340, the design invariants 311 are correlated to the operational invariants 331 to produce an integrated set of invariants 341. In the absence of automation, deriving design invariants 311 require an expert level of understanding of the physical process in SWaT 100. The invariants derived are thus accurate in their depiction of the physical processes in SWaT 100. However, due to the complexity of the task of deriving design invariants, certain hidden patterns may be overlooked by experts resulting in the invariants derived being limited in scope. On the other hand, despite ARM being blind to the control strategy specifications or the physical laws that derive the physical process of the system, the process of generating operational invariants 331 yields invariants that are insightful and complex, and that may very well have been overlooked by the experts. However, some obvious invariants might not be identified by ARM. Table 5 lists invariants that are common to both the design invariants 331 and operational invariants 331.

TABLE 5
Common invariants

| S. No. | Invariants |
|---|---|
| 1 | MV101 = OPEN ⇒ FIT101 > H |
| 2 | MV101 = CLOSED ⇒ FIT101 < L |
| 3 | FIT201 < 0.5 cmh ⇒ P101 = OFF AND |
| 4 | FIT101 > H ⇒ MV101 = OPEN |
| 5 | MV201 = OPEN ⇒ P101 = ON OR P102 = ON |
| 6 | MV201 = OPEN ⇒ P203 = ON OR P205 ON |
| 7 | FIT201 = LL ⇒ P203 = OFF AND P205 = OFF |
| 8 | P301 = ON ⇒ FIT301 > H |
| 9 | LIT301 = LL ⇒ P301 = OFF |

On the other hand, many design invariants derived 311 in step 310 differ from the operational invariants 331 generated by ARM using the operational data 321 obtained in step 320. Table 6 lists design invariants that are not common to the operational invariants 331. The reason for the different may be because the algorithm used by ARM is unable to identify certain underlying relationship between different components of the physical system, or there may have been loss of information during discretization, e.g., for LIT101, and feature removal, or the corresponding behaviour is not present/recorded in the dataset during the time window in which the data collection is carried out. For example, in Table 6, invariants 3, 20, and 37 could not have been derived because in the dataset used the state of various tanks in SWaT 100 lies between the normal ranges of L and H. Thus, the tanks can only reach LL and HH if the plant is either under attack, or an actuator is faulty, or when it is restarted with near-empty tanks.

TABLE 6
Design invariants 311 that are not common to operational invariants 331

| S. No. | Invariants |
|---|---|
| 1 | LIT101 ≤ L ⇒ MV101 = OPEN; LIT101 ≥ H ⇒ MV101 = CLOSED |
| 3 | LIT101 ≤ LL ⇒ (P101 = OFF AND P102 = OFF); LIT301 ≤ L ⇒ (P101 = ON OR P102 = ON) |
| 5 | LIT301 ≤ L ⇒ (P101 = ON OR P102 = ON); LIT301 ≥ H ⇒ (P101 = OFF OR P102 = OFF) |
| 7 | LIT301 ≤ L ⇒ MV201 = OPEN; LIT301 ≥ H ⇒ MV201 = CLOSED |
| 9 | MV201 = OPEN ⇒ (P201 = ON OR P202 = ON OR P204 = ON OR P206 = ON) |
| 10 | FIT201 ≤ L ⇒ (P201 = OFF AND P202 = OFF AND P204 = OFF AND P206 = OFF) |
| 11 | AIT201 > 260 uS/cm ⇒ (P201 = OFF OR P202 = OFF); AIT201 < 250 uS/cm ⇒ (P201 = ON OR P202 = ON) |
| 13 | AIT503 ≥ High ⇒ P201 or P202 = OFF; AIT503 ≠ High ⇒ P201 or P202 = ON |
| 15 | AIT202 < 6.95 ⇒ (P203 = OFF AND P204 = OFF); AIT202 ≥ 7.05 ⇒ (P20 = ON OR P204 = ON) |
| 17 | AIT203 > 500 mV ⇒ (P205 = OFF AND P206 = OFF); AIT203 ≤ 420 mV ⇒ (P20 = ON OR P206 = ON ) |
| 19 | AIT402 ≥ High ⇒ (P201 = OFF AND P206 = OFF); AIT402 not High ⇒ (P205 = ON OR P206 = ON) |
| 21 | LIT301 ≥ H ⇒ (P301 = OFF AND or P302 = OFF); LIT401 ≤ L ⇒ (P301 = ON OR P302 = ON) |
| 23 | LIT401 ≤ LL ⇒ (P401 = OFF AND P402 = OFF); (P401 = OFF AND P402 = OFF) ⇒ UV401 = OFF; |
| 25 | (P401 = ON OR P402 = ON) ⇒ FIT401 > H; FIT401 ≤ LL ⇒ UV401 = OFF |
| 27 | FIT401 ≤ LL ⇒ (P403 = OFF AND P404 = OFF); AIT402 ≤ L ⇒ (P403 = OFF AND P404 = OFF); |
| 29 | FIT401 ≤ L ⇒ (P403 = OFF AND P404 = OFF; AIT402 ≥ H AND LS401 ≥ L ⇒ (P403 = ON OR P404 = ON) |
| 31 | P401 = ON AND P501 = ON AND UV401 = ON ⇒ P501 = ON; P401 = OFF ⇒ P501 = OFF |
| 33 | UV401 = OFF ⇒ P501 = OFF; UV401 = ON ⇒ P501 = ON |
| 35 | FIT401 ≤ LL ⇒ P501 = OFF; AIT504 NOT HIGH ⇒ MV501 = OPEN |
| 37 | LIT101 ≥ HH ⇒ P601 = OFF; AIT202 < 7 ⇒ P601 = OFF; LS601 = L ⇒ P601 = OFF |
| 40 | AIT202 > 7 ⇒ P601 = ON; LS601 ≠ L ⇒ P601 = ON |
| 42 | One invariant each of type (8) for tanks T101, T301, and T401 |

Deriving design invariants 311 manually becomes increasingly complex with the size of the antecedent. Thus, design invariants 311 derived by comparing pairs of features, e.g., MV101 and LIT101, are relatively easy to derive than those where, for example, 6 or more features are compared simultaneously. Advantageously, invariants generated in step 330 i.e. operational invariants 331 are able to capture the relationships between multiple sensors and actuators across different processes of SWaT 100 without any constraint on the size of the antecedent. Invariants that are dependent on multiple sensors and actuators, instead of single or pairwise sensors and actuators, may be generated.

Indeed, exclusion of invariants in the monitoring system of SWaT 100 would likely lead to attacks not being detected. If only operational invariants 331 are implemented in SWaT 100, then design invariants 311 that are not common to operational invariants 331 would not be implemented. For example, (LIT101≤L⇒MV101=OPEN) which is found in the first row of Table 6, and those corresponding to type (8) would not have been implemented. Thus, a simple single point attack that spoofs LIT101 values while keeping MV101 open, could lead to an overflow in tank T101. Several similar attacks can be derived that would not be detected.

By correlating the design invariants 311 to operational invariants 331, a richer integrated set of invariants 341 is obtained. Thus, higher accuracy of attack detection is achieved than when either the design invariants 311 or operational invariants 331 is used without the other.

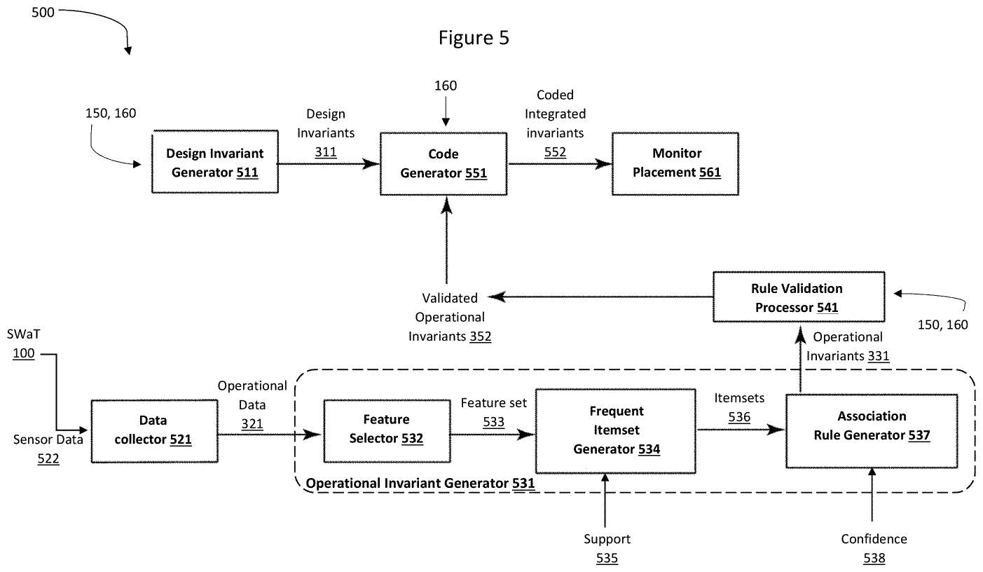

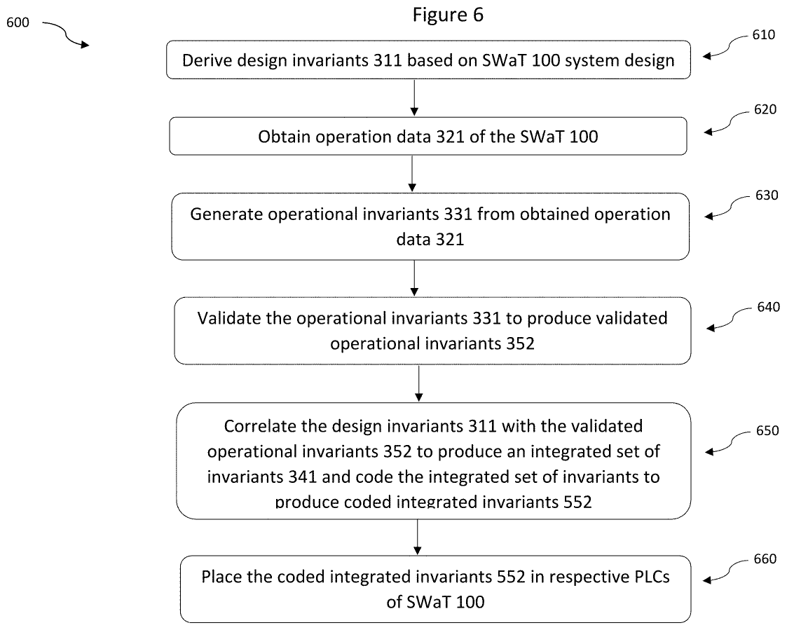

FIG. 5 illustrates an apparatus 500 for generating an invariants for distributed attack detection, and for implementing the invariants in SWaT 100. FIG. 6 illustrates a flow diagram of an exemplary method 600 which is implemented on the apparatus 500. Accordingly, the apparatus 500 and the corresponding method 600 will now be described with reference to FIGS. 5 and 6 in the following section. Notably, the apparatus 500 may be a single server, in which case the method 600 is performed on a single server, it is understood that the apparatus 500 may be multiple servers, in which case the method 600 would be performed on multiple servers. For example, one server may implement the derivation of the design invariants 311. Operational data 321 may be collected on another server, while the generation of the operational invariants 331 may be implemented on yet another server.

In the present embodiment, the apparatus 500 comprises an invariant generator 511 configured to receive plant design 150 and component specification 160 of SWaT 100. The invariant generator 511 is configured to generate design invariants 311 from the plant design 150 and the component specifications 160. Therefore, the invariant generator 511 is also termed as a design invariant generator. The design invariant generator 511 is communicatively coupled to a code generator 551 which is configured to receive the design invariants 311.

The step of deriving design invariants 311 will now be described with reference to step 610 of FIG. 6. Accordingly, at step 610, the plant design 150 and the component specifications 160 are input to the invariant generator 511. For SWaT 100, the design 150 itself could be either in the form of a P&ID diagram, or the algorithm to control various sub-processes in the plant 100. The component specifications 160 include physical attributes such as opening or closing time of a valve, inflow and outflow rates along a pipe, and dosing rates for chemicals. The design invariants 311 are output by the design invariant generator 511 at the end of step 510 to the code generator 551.

The apparatus 500 further comprises a data collector 521 which receives sensor data 522 collected from SWaT 100, the data collector 521 outputs operational data 321.

The step of obtaining operational data will now be described with reference to step 620 of FIG. 6. Accordingly, at step 620, the data collector 521 captures and saves state information generated by the sensors in the SWaT 100. The sensor data 522 is collected by capturing network packets, then decoded for state information, and the state information is saved in a historian. The operational data 321 of SWaT 100 is obtained at the end of step 520 and sent to the operational invariant generator 531. If the operational data 321 is obtained from publicly available database, then data collection is not necessary.

The apparatus 500 further comprises an operational invariant generator 531 communicatively coupled to the data collector 521. The operational invariant generator 531 receives the operational data 321 and generates the operational invariants 331 from the operational data 321. This involves a number of processes which is described under the section on “Deriving operational invariants from SWaT Dataset”. Therefore, the invariant generator 531 for generating operational invariants 331, also termed operational invariant generator, includes a number of components In particular, the operational invariant generator 531 comprises a feature selector 532 which receives the operational data 321 and outputs a feature set 533. The feature selector 532 is communicatively coupled to a frequent itemset generator 534 which receives the feature set 533 and generates frequent itemsets 536 at a preselected level of support 535 from the selected feature set 533. The frequent itemset generator is communicatively coupled to an associate rule generator 537 which then receives the frequent itemsets 536 and generates association rules (the operational invariants 331) at a preselected level of confidence 538.

The step of generating the operational invariants 331 is described herein with reference to step 630 of FIG. 6. Accordingly, at step 630, operational invariants 331 are generated by the operational invariant generator 531 from the operational data 321 obtained. First, the collected data 321 is subjected to various analysis techniques performed by a feature selector 532 to reduce the set of features to be used for generating the operational invariants 331. As this dataset is large, data reduction techniques are used to remove features that are of lower significance and therefore, the invariants generated from the limited set of features are considered most relevant.

Next, a subset of the original dataset containing only a selected feature set 533 is passed on to a frequent itemset generator 534. Frequent itemsets 536 at a preselected level of support 535 are generated by the frequent itemset generator 534 from the selected feature set 533.

The reduced itemsets 536 are then inputted to an association rule generator 537 that generates the association rules (operational invariants 331) at a preselected level of confidence 538. Support and accuracy thresholds are parameters that enable controlling invariant-explosion and in reducing chances of false alarms. In cyber physical systems, having a high enough level of accuracy is vital to prevent the false alarm rate from becoming unacceptable high.

Unlike the design invariants 311 which are derived based on physical processes of SWaT 100, the operational invariants 331 generated have not been implemented in SWaT 100 yet. Therefore, optionally, the apparatus 500 further comprises a rule validation processor 541 communicatively coupled to the operational invariant generator 531. The rule validation processor 541 is arranged to receive the operational invariants 331 from the operational invariant generator 531 and to validate the operational invariants 352 against the SWaT plant design 150 and the component specifications 160 to produce validated operational invariants 352.

The step of validating the operational invariants 331 will now be described with reference to step 640 of FIG. 6. Accordingly, at step 640, the operational invariants 331 may be validated against the SWaT plant design 150 and the component specifications 160 using the rule validation processor 541 to ensure that the operational invariants 331 can be explained by the physical behaviour of the plant sub-processes. For example, this situation is illustrated by the two operational invariants in Table 4 corresponding to an antecedent size of 7. These invariants indicate a seeming relationship between the backwash process in stage 6 and the raw water treatment process in stage 1. A deep look at the control algorithm for stage 1 reveals no such relationship implying that MV101 is opened or closed solely based on the water level in tank T101 as measured by LIT101. Including such rare invariants would lead to false alarms when MV101 is off but the antecedent of the invariant is true. The invariants that fail the validation process are then filtered out. This filtering process leads to a reduced set of invariants i.e. validated operational invariants 352. Advantageously, validating the operational invariants 331 against the plant design 150 and component specifications 160 ensures that invalid operational invariants are not implemented.

The rule validation processor 541 is communicatively coupled to the code generator 551 which receives the validated operational invariants 352. Notably, if the rule validation processor 541 is not required, then the operational invariant generator 531 may be communicatively coupled directly to the code generator 551 (not shown in FIG. 5),

The code generator 551 comprises a processor (not shown) which correlates the design invariants 311 and validated operational invariants 352 to produce the integrated set of invariants 341. The code generator 551 then encodes the integrated set of invariants 341 to produce coded integrated invariants 552.

The step of producing coded integrated invariants 552 will now be described with reference to step 650 of FIG. 6. Accordingly, at step 650, the design invariants 311 and the validated operational invariants 352 are correlated by the processor in the code generator 541 to produce the integrated set of invariants 341. The integrated set of invariants 341 are then coded by the code generator 541 for use by the PLCs. In the present embodiment, the integrated set of invariants 341 is coded using Structured Text—a commonly used programming language for PLCs. However, any suitable programming language that is known to the skilled person may also be used. Notably, the integrated set of invariants 341 do not include transient states. For example, the stable states of a motorized valve are OPEN and CLOSED, transient states include OPEN→CLOSED and state CLOSED→OPEN. Component specifications 160 are used to ensure that invariants are evaluated in stable states. The values of n and ε in (8) are also determined in this step. These values are tuned when the plant is operational (not shown in FIG. 5).

The apparatus further comprises a monitor placement 561 communicatively coupled to the code generator 551. The monitor placement 561 receives the coded integrated invariants 552 and places the coded integrated invariants 552 inside respective PLCs in SWaT 100.

Placement of the coded integrated invariants 552 will now be described with reference to step 660 of FIG. 6. Accordingly, at step 660, the monitor placement 561 places the coded integrated invariants 552 inside each PLC. In the exemplary embodiment using SWaT 100, a total of 53 coded invariants (9 in Table 5 and 44 in Table 6) are generated and placed in their corresponding PLCs. Notably, a local invariant is placed in its corresponding PLC while a global invariant is placed in all PLCs that obtain sensor data and send control commands used in the invariant. For example, invariant (5) is placed in PLC1 while invariant (6) is placed in PLCs 1 and 3. In this manner, the coded invariants 552 serve as monitors for detecting a distributed attack on a cyber-physical system having a number of system components.

### CONCLUSION

In the present disclosure, an attack detection system which uses the control strategy of the plant system, as well as association rule mining, to discover the inherent behaviour of the plant system for detecting process anomaly is defined. The design invariants 311 and the operational invariants 331 are separately derived/generated and a combined set of invariants 341 is generated, with no redundancy, and implemented to monitor a plant process. Doing so improves the accuracy of distributed attack detection and reduces false alarms more than when either the design invariants 311 or the operational invariants 331 are used independently. Having said that, if operational invariants 331 are to be used alone, they should be augmented with other approaches to derive invariants that correspond to continuous variables such as LIT in SWaT 100. Furthermore, operational invariants may be continuously generated while operational data 321 is being collected during plant operation. Doing so would enable retuning parameters, e.g. opening and closing times of a valve, as the plant gets older and components degrade. Notably, tuning the parameters of design invariants 311 is ineffective as the derivation assumes parameters available at the time of plant design.

Additionally, derivation of the design parameters should be automated if it is to be used in any large plants. Generally such plants have hundreds, if not thousands, of sensors and actuators. It would be practically impossible to generate manually even simple invariants with an antecedent of size 1 in such plants.

Violation of an invariant does not necessarily imply detection of a cyber attack. It could also be due to the failure of one of more components. State information has to be analysed to identify if an alert generated using monitors derived from invariants is due to cyber attack or component failure.

As it can be appreciated from the described embodiments, process anomaly is used for detecting cyber-physical attacks on critical infrastructure such as plants for water treatment and electric power generation. Identification of process anomaly is possible using rules that govern the physical and chemical behavior of the process within a plant. These rules, often referred to as invariants, or monitors when implemented, is derived/generated from an integration of both the plant design and from the data generated in an operational plant.

Although the present disclosure has been described with reference to specific exemplary embodiments, various modifications may be made to the embodiments without departing from the scope of the invention as laid out in the claims. For example, each invariant is coded in an appropriate language depending on where in the plant it is placed. In SWaT 100, the invariants are coded in structured text and placed inside the PLCs to serve as process monitors. However, these monitors could also be placed at level 1 and level 0 of on the communications network. However, care must be taken in doing so to ensure that all data needed to evaluate the invariants is available on the network. It is understood that the skilled person would have knowledge of the best location(s) to place the invariants in a plant.

Furthermore, while the association rules are mined using the FP-growth frequent pattern mining algorithm which is implemented using Python Orange-Associate Library, ARM could be implemented using any one of many algorithms that are available to the skilled person. Similarly, different heuristics techniques that are at the skilled person's disposal may be implemented for the generation of the design invariants 311.

The various embodiments as discussed above may be practiced with steps in a different order as disclosed in the description and illustrated in the Figures. Modifications and alternative constructions apparent to the skilled person are understood to be within the scope of disclosure.

1. A method of generating invariants for distributed attack detection on a cyber physical system having a number of system components, comprising
(i) deriving design invariants based on system design of the cyber physical system including physical specifications of the system components;
(ii) obtaining operational data of the cyber physical system including operational attributes of the system components;
(iii) generating operational invariants from the obtained operational data; and
(iv) correlating the operational invariants with the design invariants to generate an integrated set of invariants for detecting distributed cyber attacks of the cyber physical system.

2. A method according to claim 1, wherein the operational invariants are validated operational invariants.

3. A method according to claim 2, wherein producing the validated operational invariants comprises validating the operational invariants against the system design of the cyber physical system.

4. A method according to claim 1, wherein obtaining the operational data comprises collecting network packets, decoding the network packets for state information of sensors to derive the operational attributes of the system components, and producing an invariant dataset for generating the operational invariants.

5. A method according to claim 4, further comprising reducing the invariant dataset to produce a reduced invariant dataset for generating the operational invariants.

6. A method according to claim 5, wherein producing the reduced invariant dataset comprises processing the operational attributes of the system components to produce discrete valued attributes.

7. A method according to claim 6, wherein the operational attributes are real valued attributes, and producing discrete valued attributes comprises discretizing the real valued attributes to binary, ternary, and n-ary, n>2, valued attributes.

8. A method according to claim 6, further comprising monitoring the sensors corresponding to the system components of the discrete valued attributes for changes in the discrete values over a specific period of time.

9. A method according to claim 8, further comprising selecting operational attributes which exhibit change in the discrete values as part of the reduced invariant dataset for generating the operational invariants.

10. A method according to claim 6, further comprising forming one or more of the discrete valued attributes into itemsets, and selecting the itemsets that satisfy a preselected minimum support level as part of the reduced invariant dataset.

11. A method according to claim 10, further comprising generating association rules that satisfy a preselected minimum confidence level from the itemsets, wherein the operational invariants are the association rules for defining a relationship between the operational attributes of each system component.

12. A method according to claim 1, wherein correlating the operational invariants with the design invariants comprises comparing the operational invariants to the design invariants, and removing highly correlated attributes to form the integrated set of invariants.

13. A method according to claim 1, further comprising coding the integrated set of invariants as respective computer codes; and programming controllers with the respective computer codes for monitoring process anomalies in the cyber physical system.

14. A method according to claim 1, wherein the cyber physical system is a water treatment or power generation plant.

15. Apparatus for generating invariants to detect distributed attacks on a cyber physical system having a number of system components, comprising
a first invariant generator configured to derive design invariants based on system design of the cyber physical system including physical specifications of the system components;
a data collector configured to obtain operational data of the cyber physical system including operational attributes of the system components;
a second invariant generator configured to generate operational invariants from the obtained operational data; and
a processor configured to correlate the operational invariants with the design invariants to generate an integrated set of invariants for detecting distributed cyber attacks on the cyber physical system.

16. Apparatus according to claim 15, wherein the operational invariants are validated operational invariants.

17. Apparatus according to claim 16, further comprising a rule validation processor configured to validate the operational invariants against the system design of the cyber physical system to produce the validated operational invariants.
